(19) United States
(12) Patent Application Publication
(10) Pub. No.: US 2015/0055439 A1
(43) Pub. Date: Feb. 26, 2015

(54) ADJUSTABLE DISPLAY ANGLE CLOCK

(71) Applicant: Robert F. Lewis, Pittston, PA (US)

(72) Inventor: Robert F. Lewis, Pittston, PA (US)

(21) Appl. No.: 14/298,587

(22) Filed: Jun. 6, 2014

Related U.S. Application Data
(60) Provisional application No. 61/868,539, filed on Aug. 21, 2013.

(51) Int. Cl. G04G 17/00; G04G 9/00

(52) U.S. Cl. CPC G04G 17/00; G04G 9/00
USPC 368/88

(57) ABSTRACT

An adjustable angle alarm clock for allowing the time display of a clock to be rotated up to ninety degrees in either direction so that the time can be read by a user in a lying position. The adjustable angle alarm clock comprises a clock base with a display assembly rotatably disposed in the clock base. A rocker switch disposed on the clock base, under the display assembly enables the display assembly to be selectively rotated relative to the clock base. An electric rotation element disposed at the contact point between the clock base and the display assembly causes the display assembly to be rotated in a clockwise or counter-clockwise direction in response actuation of the rocker switch in that direction.

### CROSS REFERENCE TO RELATED APPLICATIONS

This application claims the benefit of and incorporates by reference co-pending U.S. provisional patent application Ser. No. 61/868,539 filed Aug. 21, 2013.

### BACKGROUND OF THE INVENTION

1. Field of the Invention

This invention relates generally to a clock structure and, more particularly, to an alarm clock having a rotatable display.

2. Description of the Prior Art

The need to wake up at a pre-appointed time in human societies seemingly predates the beginning of recorded time. In many situations, such as in war, such a need may have been a matter of life or death. In present times, instances such as fixed work schedules means that such a need still often has significant role in one's life or livelihood.

The use of alarm clocks to wake a user up at a desired time is well known. Conventional alarm clock will commonly include an upright display and be programmable to generate an audible or other sensory alert at a desired. The alarm clock can then be placed next to the bed of a user, so as to wake the user up at the programmed time. But because alarm clocks are often placed next to a user's bed, where a user will often be in a supine or prone position, a problem that exists with conventional alarm clocks is that to read the upright display of the alarm clock, a user must grab the alarm clock to hold it in the same direction of the user's head or turn his head in a way to match that of the alarm clock. Thus, there remains a need for an adjustable angle alarm clock which would allow the display of a clock to be rotated to an angle suitable for viewing from a lying position. It would be helpful if such an adjustable angle alarm clock included a display which could be rotated to be viewable to users in a supine or prone position, on either side of a bed. It would be additionally desirable for such an adjustable angle alarm clock to include a display which does not rotate beyond to ninety degrees in either direction.

The Applicant's invention described herein provides for an alarm clock adapted with a display element which can be rotated and set at a plurality of angles. The primary components of Applicant's an adjustable angle alarm clock are a clock base, a display element, a switch, and a rotation element. When in operation, the adjustable angle alarm clock allows a user to set the display element at one of a plurality of angles so as to be viewable from which lying down in any position. As a result, many of the limitations imposed by the fixed nature of the display of existing alarm clocks are removed.

### SUMMARY OF THE INVENTION

An adjustable angle alarm clock for allowing the time display of a clock to be rotated up to ninety degrees in either direction so that the time can be read by a user in a lying position. The adjustable angle alarm clock comprises a clock base with a display assembly rotatably disposed in the clock base. A rocker switch disposed on the clock base, under the display assembly enables the display assembly to be selectively rotated relative to the clock base. An electric rotation element disposed at the contact point between the clock base and the display assembly causes the display assembly to be rotated in a clockwise or counter-clockwise direction in response actuation of the rocker switch in that direction.

In an alternate embodiment, manual force is used to rotate the display in a desired direction, with a manual rotation element employed to maintain the set position in the absence of manual force. In such an embodiment, the manual rotation element additionally acts to prevent the display assembly from being rotated beyond ninety degrees in either direction.

It is an object of this invention to provide an adjustable angle alarm clock which would allow the display of a clock to be rotated to an angle suitable for viewing from a lying position.

It is another object of this invention to provide an adjustable angle alarm clock which includes a display which could be rotated to be viewable to user's in a supine or prone position, on either side of a bed.

It is yet another object of this invention to provide an adjustable angle alarm clock which includes a display which cannot be rotated beyond ninety degrees in either direction.

These and other objects will be apparent to one of skill in the art.

### BRIEF DESCRIPTION OF THE DRAWINGS

FIG. 1a is a front view of an adjustable angle alarm clock built in accordance with the preferred embodiment of the present invention having its display in a rotated position.

FIG. 1b is a block diagram of the electrical components of an adjustable angle alarm clock built in accordance with the preferred embodiment of the present invention.

FIG. 2 is a front view of an adjustable angle alarm clock built in accordance with the preferred embodiment of the present invention having its display in a rotated position and including a degree display.

FIG. 3 is a front view of an adjustable angle alarm clock built in accordance with an alternate embodiment of the present invention having its display in the default, upright position.

FIG. 4 is a front view of the adjustable angle alarm clock built in accordance with an alternate embodiment of the present invention having its display in a rotated position.

FIG. 5a is a back elevational view of the display assembly of the adjustable angle alarm clock built in accordance with an alternate embodiment of the present invention.

FIG. 5b is a side elevational view of the display assembly of the adjustable angle alarm clock built in accordance with an alternate embodiment of the present invention.

FIG. 6 is a front elevational view of the clock base of the adjustable angle alarm clock built in accordance with an alternate embodiment of the present invention wherein the display element is removed.

FIG. 7 is a cross sectional view of the combined rotation element of the adjustable angle alarm clock built in accordance with an alternate embodiment of the present invention.

### DETAILED DESCRIPTION OF THE INVENTION

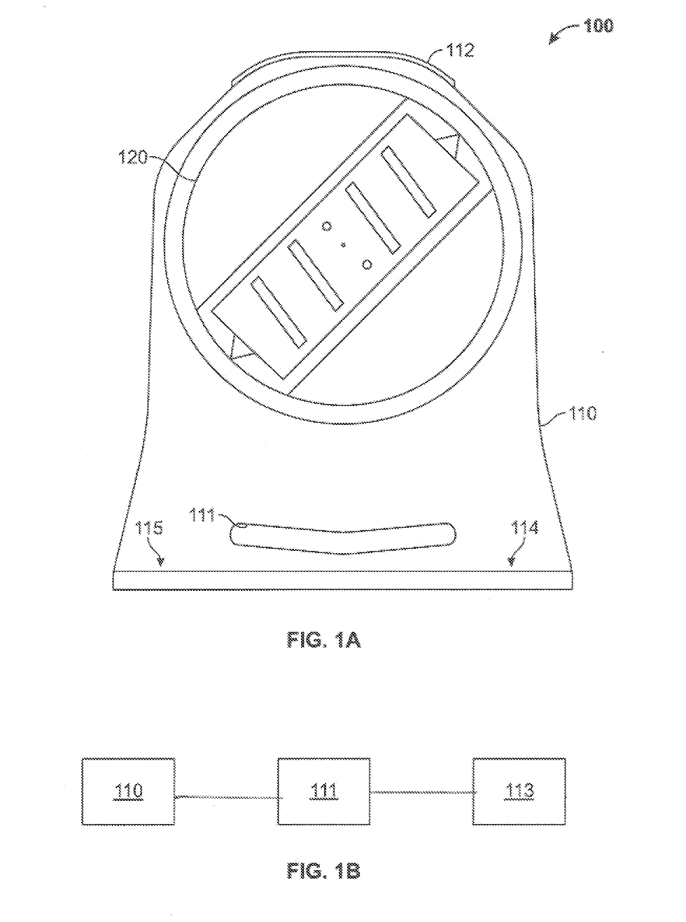

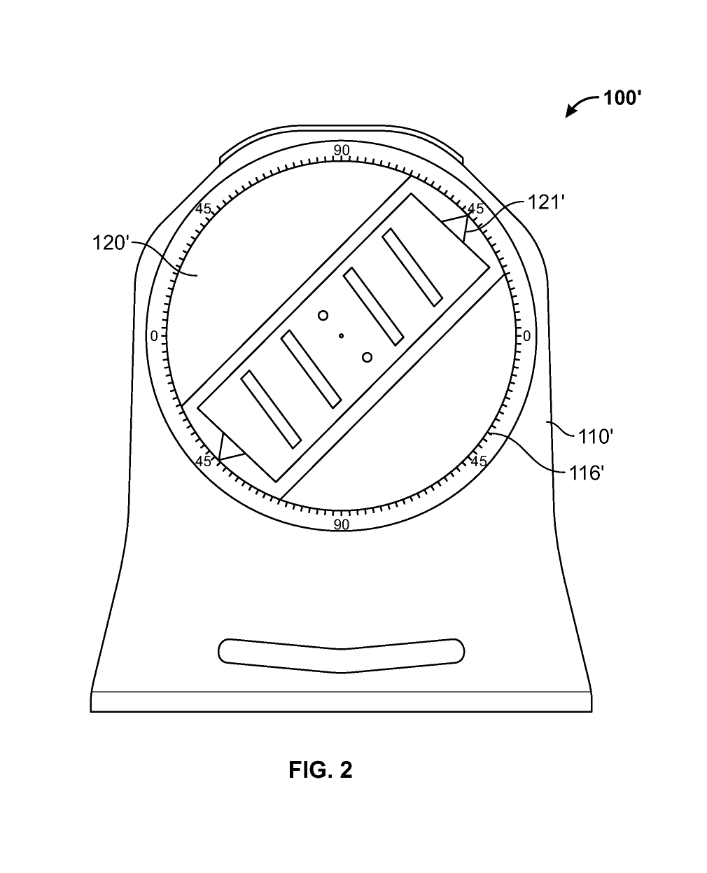

Referring now to the drawings and in particular FIGS. 1a and 1b, the preferred embodiment of an adjustable angle alarm clock 100 is shown having a clock base 110 and a display assembly 120 rotatably disposed in the clock base 110. The clock base 110 additionally includes a rocker switch 111 and a snooze button 112. The rocker switch 111 is electrically connected to an internal rotation element 113, defined as a electric motor configured to output mechanical rotation in a clockwise direction or a counterclockwise direction in response to the receipt of electrical power, and an electrical power source 101. It is contemplated that the power source 101 is a conventional electrical power source for conventional clocks, such as a connection to a conventional electrical outlet or an internal battery. It is further contemplated that other conventional switching mechanisms may be employed in the alternative to the rocker switch 111.

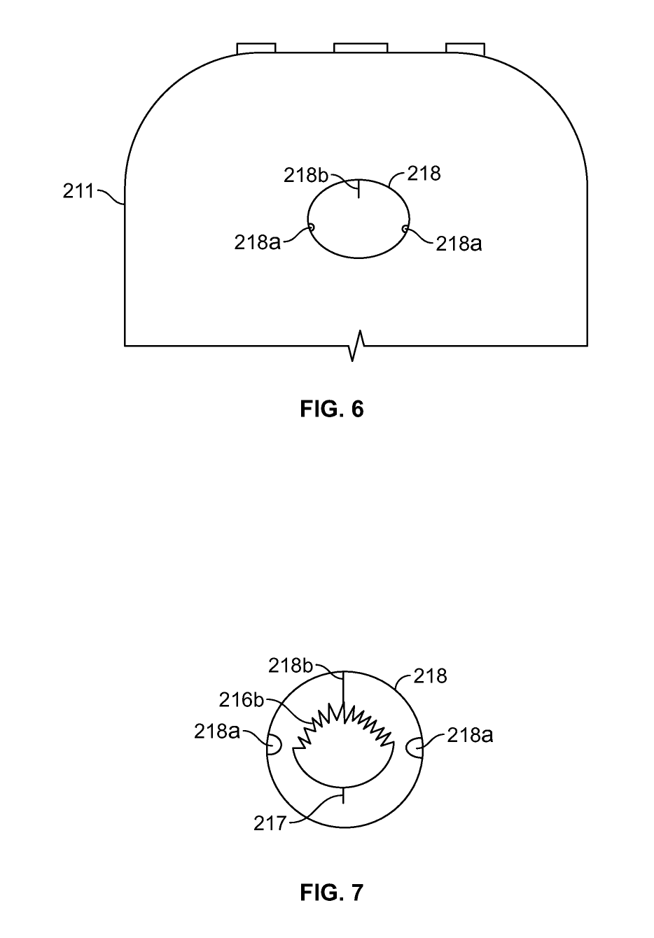

The internal rotation element 113 is mechanically connected to the display assembly 120 and thus able to rotate the display assembly 120 when it receives electricity. The rocker switch 111 makes an electrical circuit to supply electricity from the power source 101 to the internal rotation element 113 when manual pressure in a clockwise engaging direction 114 or in a counterclockwise engaging direction 115 is placed in the rocker switch 111. Manual pressure in a clockwise engaging direction 114 cause the internal rotation element 113 to rotate the display assembly 120 clockwise, while manual in a counterclockwise engaging direction 115 cause the internal rotation element 113 to rotate the display assembly 120 counterclockwise. Because it is desired that the internal rotation element 111 only rotate the display element 90 degrees in either direction, it includes track stoppers of the design shown in FIG. 6, infra, to cease rotation when the internal rotation element 111 has rotated 90 degrees even if the motor remains engaged and spinning

Referring now to FIG. 2, a modified an adjustable angle alarm clock 100′ has a clock base 110′ which includes a illuminated measurement scale ring 116′ which displays degrees from 0 to 90. When such a ring is included, the display element 120′ will also include a pair of illuminated arrows 121′ which point to scale to allow a user to readily ascertain the rotation degree at which the display element 120′ is presently set. It is contemplated that the illuminated measurement scale ring 116′ and the illuminated arrows 121′ utilize embedded lighting elements and the electrical power source for conventional clocks to provide the illumination effect.

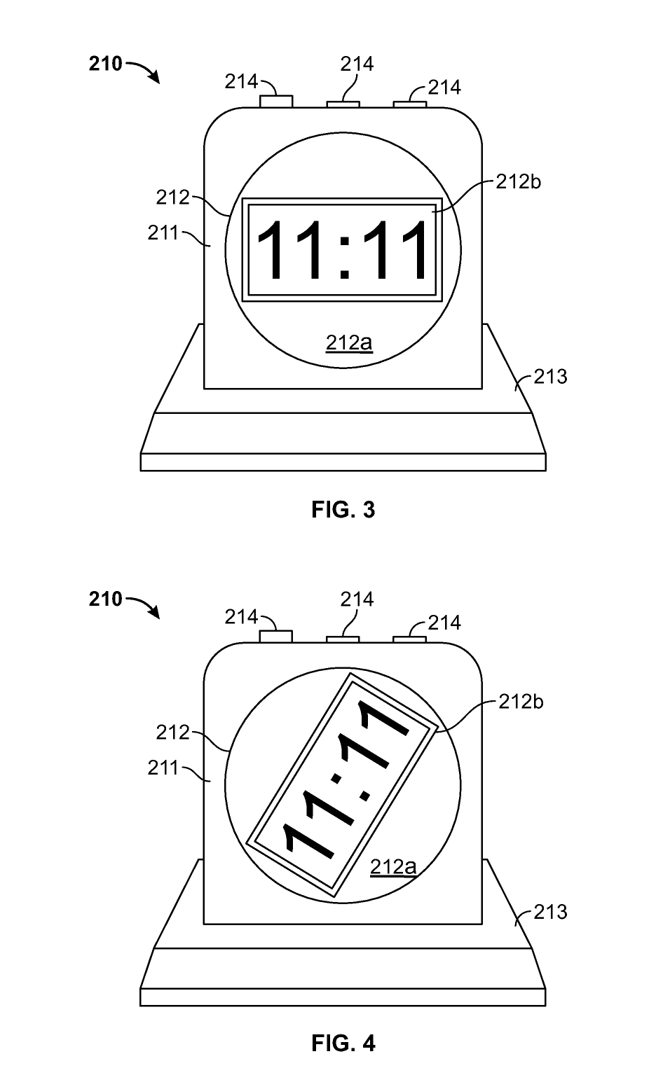

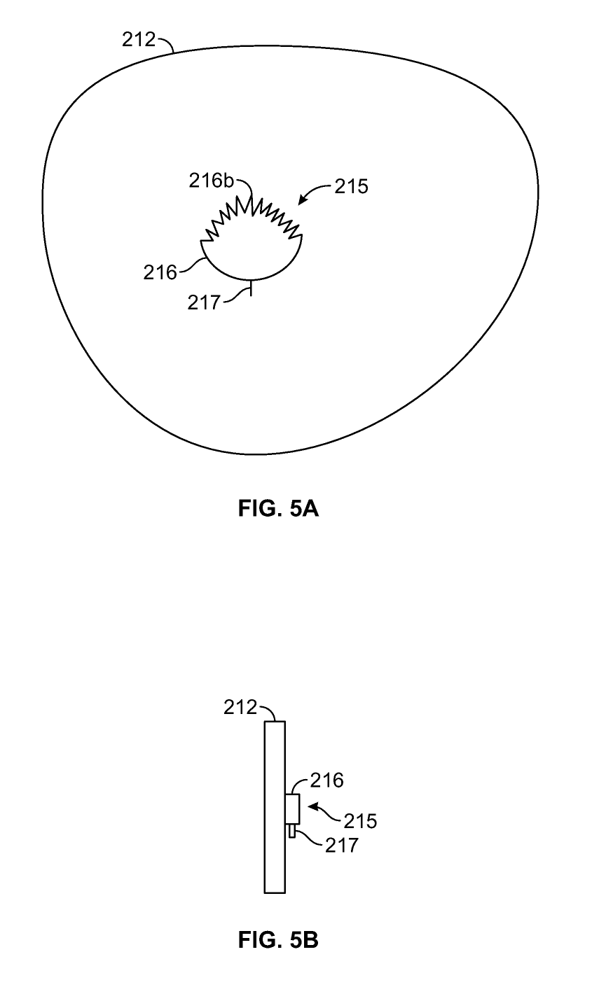

Referring now to FIGS. 3, 4, 5a, 5b, 6, and 7, an alternate embodiment of an adjustable angle alarm clock 210 is shown having a clock base 211 and a display assembly 212 rotatably disposed in the clock base 211. In an embodiment of the present invention, common aspects of traditional alarm clocks, such as a base stand 213, and programming buttons 214 may be included. The display assembly 212 is defined as a rotatable disc sized 212a to fit in the clock base 211 and configured with a digital number display 212b for a visual output. It is understood, however, that a hand display or other established clock displays may be employed. The programming buttons 214 employ rocker switches in the illustrated embodiments, but may in alternate embodiments employ momentary switches or mixes of other conventional switching mechanisms.

The back of the display assembly 212 includes a rotation member 215. The rotation member 215 has a circular body 216 having half of its perimeter defined by a smooth surface and the other half defined by a plurality of ridges 216b. In addition, a rigid member stopper 217 extends from the smooth surface of the circular body.

If the display assembly 212 is removed from the clock base 211, a rotation track 218 in the clock base 211 is exposed. The rotation track 218 forms an indentation in the clock base 211 which is sized to receive the rotation member 215. The rotation track includes two rigid track stoppers 218a and one flexible track setter 218b.

When the display assembly 212 is inserted into with the clock base 211, the rotation member 215 and the rotation track 218 engage to form the adjustable angle alarm clock's rotation element. The rotation element works through the interaction between the ridges 216b and the member stopper 217 on one hand, and the track stoppers 218a and track setter 218 on the other hand. The ridges 216b of the rotation member are frictionally engaged by the track setter 218b by way of the track setter 218b's structure that is configured to extend down into the space between a given ridge 216b and be deformed as each ridge 216b is rotated past it due to manual force in a rotational direction. In the absence of such manual force, the track setter 218b will maintain its position between the two ridges between which it was placed by the manual force. In this way, the rotation element allows the display assembly to maintain a desired rotational position once set.

The member stopper 217 and the track stoppers 218a operate together to prevent the display assembly from being rotated beyond ninety degrees in either direction. If the display assembly is rotated in a clockwise direction, the member stopper 217 will also rotate clockwise until it is stopped the track stopper 218a on the left side of FIG. 6. If the display assembly is rotated in a counter-clockwise direction, the member stopper 217 will likewise rotate counter-clockwise until it is stopped the track stopper 218a on the right side of FIG. 6. The track stoppers 218a are sized to be small enough to not engage the ridges 216b so that the ridges pass to allow the display assembly 212 to otherwise rotate.

It is understood that the conventional features of alarm clocks may be included on an adjustable angle alarm clock built in accordance with the present invention, such as AM/FM radio, an IPod/IPhone port, and/or a USB port.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An adjustable angle alarm clock comprising:
a clock base;
a display assembly connected to and rotatably disposed in said clock base; and
a rotation element, defined as an electric motor configured to output mechanical rotation in a clockwise direction or a counterclockwise direction, wherein said rotation element is configured to convert electrical power from a power source to mechanical movement that rotates the display assembly at least one of clockwise and counterclockwise.

2. The adjustable angle alarm clock of claim 1, wherein said rotation element is defined as an electric motor electrically connected to a power source and mechanically connected to the display assembly.

3. The adjustable angle alarm clock of claim 1, additionally including a switch adapted to selectively supply electrical power from said power source to said rotation element.

4. The adjustable angle alarm clock of claim 3, wherein said switch is defined by a rocker switch.

5. The adjustable angle alarm clock of claim 4, wherein said rocker switch is configured to selectively supply electrical power from said power source to said rotation element to cause the rotation element to rotate in a first direction at a given time and to selectively supply electrical power from said power source to said rotation element to cause the rotation element to rotate in a second direction at another time.

6. The adjustable angle alarm clock of claim 1, wherein the display assembly and rotation element are configured to resist rotation of the display assembly beyond 90 degrees in either direction.

7. The adjustable angle alarm clock of claim 1, additionally comprising a measurement scale ring on the clock base surrounding the display assembly.

8. The adjustable angle alarm clock of claim 7, additionally comprising a pair of arrows on said display assembly, wherein said arrows are configured to point towards the measurement scale ring.

9. The adjustable angle alarm clock of claim 8, wherein the measurement scale ring and the pair of arrows are illuminable.
